(19) United States
(12) Patent Application Publication
(10) Pub. No.: US 2010/0169650 A1
(43) Pub. Date: Jul. 1, 2010

(54) STORAGE MINIMIZATION TECHNIQUE FOR DIRECT ANONYMOUS ATTESTATION KEYS

(76) Inventors: Ernest F. Brickell, Hillsboro, OR (US); Jiangtao Li, Beaverton, OR (US)

Correspondence Address: INTEL CORPORATION;c/o CPA Global, P.O. BOX 52050, MINNEAPOLIS, MN, 55402, US

(21) Appl. No.: 12/347,581

(22) Filed: Dec. 31, 2008

(51) Int. Cl. H04L 9/32; H04L 9/00

(52) U.S. Cl. 713/176; 380/44; 713/168

(57) ABSTRACT

A storage minimization technique for direct anonymous attestation (DAA) keys is presented. In one embodiment, the method includes deriving a random portion of a (DAA) private key from a device's fuse key, computing a point on an elliptical curve from the derived random portion and a master private key, and storing only one coordinate of the point in fuses within the device. Other embodiments are described and claimed.

### FIELD OF THE INVENTION

One or more embodiments of the invention relate generally to the field of cryptography. More particularly, one or more of the embodiments of the invention relates to a storage minimization technique for direct anonymous attestation keys.

### BACKGROUND OF THE INVENTION

For many modern communication systems, the reliability and security of exchanged information is a significant concern. To address this concern, the Trusted Computing Platform Alliance (TCPA) developed security solutions for platforms. In accordance with a TCPA specification entitled “Main Specification Version 1.1b,” published on or around Feb. 22, 2002, each personal computer (PC) is implemented with a trusted hardware device referred to as a Trusted Platform Module (TPM).

During operation, an outside party (referred to as a “verifier”) may require authentication of the TPM. This creates two opposing security concerns. First, the verifier needs to be sure that requested authentication information is really coming from a valid TPM. Second, an owner of a PC including the TPM wants to maintain as much privacy as possible. In particular, the owner of the PC wants to be able to provide authentication information to different verifiers without those verifiers being able to determine that the authentication information is coming from the same TPM.

Direct Anonymous Attestation (DAA) is a scheme that enables remote authentication of TPM, while preserving the privacy of the user of the platform that contains the module. In the DAA protocol, there are several entities: an issuer, platforms each of which has a unique membership key issued by the issuer, and verifiers who want to get convinced by a platform that the platform has a membership key. Each platform consists of two separate parts: a host and a TPM embedded into the platform. A DAA scheme consists of (1) a key generation procedure that produces the group public key and also a master private key for the issuer, (2) a join protocol that allows a platform to obtain a unique DAA private key from the issuer, (3) a sign algorithm for a platform to sign a message using its DAA private key, and (4) a verification algorithm to check signatures for validity with respect to the group public key. Instead of a join protocol the issuer may generate a DAA private key for the platform and store the key in fuses of the platform during the manufacturing process.

### BRIEF DESCRIPTION OF THE DRAWINGS

The various embodiments of the present invention are illustrated by way of example, and not by way of limitation, in the figures of the accompanying drawings and in which:

FIG. 1 is a block diagram illustrating a system featuring a platform implemented with a trusted platform module (TPM), in accordance with one embodiment;

FIG. 2 is a block diagram further illustrating the platform of FIG. 1, in accordance with one embodiment;

FIG. 3 is a block diagram further illustrating the TPM of FIGS. 1 and 2, in accordance with one embodiment;

FIG. 4 is a flowchart illustrating a method for minimizing the storage of a DAA private key, in accordance with one embodiment; and

FIG. 5 is a flowchart illustrating a method for reconstructing a DAA private key from the minimized storage form, in accordance with one embodiment.

### DETAILED DESCRIPTION

In the following description, certain terminology is used to describe certain features of one or more embodiments of the invention. For instance, “platform” is defined as any type of communication device that is adapted to transmit and receive information. Examples of various platforms include, but are not limited or restricted to computers, personal digital assistants, cellular telephones, set-top boxes, facsimile machines, printers, modems, routers, smart cards, USB tokens, an identification card, driver's license, credit card or other like form factor device including an integrated circuit, or the like. A “communication link” is broadly defined as one or more information-carrying mediums adapted to a platform. Examples of various types of communication links include, but are not limited or restricted to electrical wire(s), optical fiber(s), cable(s), bus trace(s), or wireless signaling technology.

A “verifier” refers to any entity (e.g., person, platform, system, software, and/or device) that requests some verification of authenticity or authority from another entity. Normally, this is performed prior to disclosing or providing the requested information. A “prover” refers to any entity that has been requested to provide some proof of its authority, validity, and/or identity. A “prover” may be referred to as “signer” when the prover responds to an authentication request by signing a message using a private signature key. An “issuer” defines a trusted membership group and engages with hardware devices to join the trusted membership group. A “device manufacturer,” which may be used interchangeably with “certifying manufacturer,” refers to any entity that manufactures or configures a platform or device (e.g., a Trusted Platform Module). An issuer may be a device/certifying manufacturer.

As used herein, to “prove” or “convince” a verifier that a prover has possession or knowledge of some cryptographic information (e.g., signature key, a private key, etc.) means that, based on the information and proof disclosed to the verifier, there is a high probability that the prover has the cryptographic information. To prove this to a verifier without “revealing” or “disclosing” the cryptographic information to the verifier means that, based on the information disclosed to the verifier, it would be computationally infeasible for the verifier to determine the cryptographic information. Such proofs are hereinafter referred to as direct proofs.

Throughout the description and illustration of the various embodiments discussed hereinafter, coefficients, variables, and other symbols (e.g., “h”) are referred to by the same label or name. Therefore, where a symbol appears in different parts of an equation as well as different equations or functional description, the same symbol is being referenced.

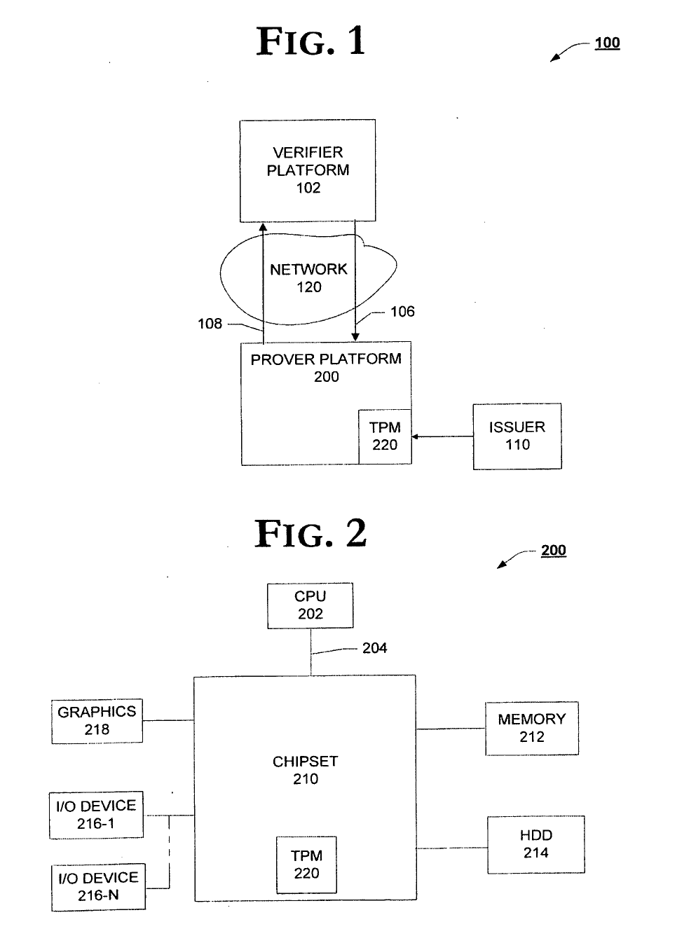

FIG. 1 illustrates system 100 featuring a platform implemented with a trusted hardware device (referred to as “Trusted Platform Module” or “TPM”) in accordance with one embodiment. A first platform 102 (Verifier) transmits an authentication request 106 to a second platform 200 (Prover) via network 120. In response to request 106, second platform 200 provides the authentication information 108. In one embodiment, network 120 forms part of a local or wide area network, and/or a conventional network infrastructure, such as a company's Intranet, the Internet, or other like network.

Additionally, for heightened security, first platform 102 may need to verify that prover platform 200 is manufactured by either a selected device manufacturer or a selected group of device manufacturers (hereinafter referred to as “device manufacturer(s) (issuer) 110”). In one embodiment, first platform 102 challenges second platform 200 to show that it has cryptographic information (e.g., a private signature key) generated by issuer 110. Second platform 200 replies to the challenge by providing authentication information, in the form of a reply, to convince first platform 102 that second platform 200 has cryptographic information generated by issuer 110, without revealing the cryptographic information or any device/platform identification information, referred to herein as “unique, device identification information” to enable a trusted member device to remain anonymous to the verifier.

Issuer 110 generates a group certificate that comprises group public key and public parameters, the security relevant information of the trusted membership group. Once the Platform 200 group public/private key is generated, a certification procedure of each member device of the trusted group is performed. As part of the certification process, issuer 110 provides the group certificate to the members or devices of the trusted group. The distribution of cryptographic parameters associated with the group certificate from a prover (e.g., second platform 200) to verifier 102 may be accomplished in a number of ways. However, these cryptographic parameters should be distributed to verifier 102 in such a way that verifier 102 is convinced that the group certificate was generated by issuer 110.

For instance, one accepted method is by distributing the parameters directly from issuer 110 to verifier 102. Another accepted method is by distributing the group certificate signed by a certifying authority, being issuer 110 as one example. In this latter method, the public key of the certifying authority should be distributed to verifier 102, and the signed group public key (group certificate) can be given to each member in the trusted group (prover platform). Prover platform 200 can then provide the group certificate to verifier 102.

FIG. 2 is a block diagram further illustrating an embodiment of anonymous platform 200 including TPM 220 having a group certificate that is common to all of the TPMs in the same group as TPM 220, and a DAA private key to provide a digital signature that can be verified using the group public key in the group certificate. In one embodiment, TPM 220 in combination with platform 200 generates authentication information using a unique DAA private key (as described in more detail hereinafter) to prove to a verifier that platform 200 is a member of a trusted membership group defined by an issuer 110 (e.g., device manufacturer), without disclosure of any unique device identification information including the private unique signature key to enable trusted platform 200 to remain anonymous to verifier 102 (FIG. 1). Representatively, computer system 200 comprises a processor system bus (front side bus (FSB)) 204 for communicating information between processor (CPU) 202 and chipset 210. As described herein, the term “chipset” is used in a manner to collectively describe the various devices coupled to CPU 202 to perform desired system functionality.

Representatively, graphics block 218, as well as hard drive devices (HDD) 214 and main memory 212 are coupled to chipset 210. In one embodiment, graphics block 218 comprises a graphics chipset, or alternatively, chipset 210 may incorporate graphics block 218 and operate as a graphics memory controller hub (GMCH). In one embodiment, chipset 210 is configured to include a memory controller and/or an input/output (I/O) controller to communicate with I/O devices 216 (216-1, . . . , 216-N). In one embodiment, main memory 212 may include, but is not limited to, random access memory (RAM), dynamic RAM (DRAM), static RAM (SRAM), synchronous DRAM (SDRAM), double data rate (DDR) SDRAM (DDR-SDRAM), Rambus DRAM (RDRAM) or any device capable of supporting high-speed buffering of data.

FIG. 3 further illustrates Trusted Platform Module (TPM) 220 of second platform 200, in accordance with one embodiment. TPM 220 is a cryptographic device that is manufactured by device manufacturer. In one embodiment, TPM 220 comprises processor unit 222 with a small amount of on-chip memory encapsulated within a package. In one embodiment, the encapsulated memory may be used to store a unique DAA private key 230 generated during a reconstruction procedure described in more detail with reference to FIG. 5. TPM 220 is configured to provide authentication information to first platform 102 that would enable it to determine that the authentication information is transmitted from a valid TPM. The authentication information used is randomized data that would make it highly likely that the TPM's or second platform's identify can be determined.

In one embodiment, TPM 220 further comprises non-volatile memory 224 (e.g., flash) to permit storage of cryptographic information such as one or more of the following: keys, hash values, signatures, certificates, etc. In one embodiment, the cryptographic information is a private signature key reconstructed from minimized key 254, which is burned into fuses 250, along with fuse key 252, by issuer 110. Of course, it is contemplated that such information may be stored within external memory 212 of platform 200 in lieu of flash memory 224. The cryptographic information may be encrypted, especially if stored outside TPM 220.

In one embodiment, TPM 220 includes authentication logic 240 to respond to an authentication request from a verifier platform. In one embodiment, authentication logic 240 computes a digital signature according to a received message using DAA private key 230 to convince or prove to the verifier platform that TPM 220 has stored cryptographic information generated by an issuer of a trusted membership group, without revealing any unique device/platform identification information. As a result, authentication logic 240 performs the requested authentication while preserving the identity of the prover platform to maintain anonymity of platform 200. In one embodiment, authentication logic 240 constructs a DAA private key 230 from fuse key 252 and minimized key 254, as described in more detail with reference to FIG. 5. In one embodiment, minimized key 254 is 256 bits with 128-bit security level.

In one embodiment, authentication logic 240 enables one to prove that he is a member in a group without revealing any information about his identity. A member of a group has a DAA private key that may be used to prove membership in the group. In one embodiment, the DAA private key consists of a private member key and a membership certificate. The DAA private key is unique for every different member of the group and each member selects a secret random value as a private member key of the member that is unknown to the issuer. However, a group public key of the trusted membership group is the same for all members of the group.

As described herein, the issuer, such as issuer 110, is the entity that establishes that a person (or an entity) is a member of a group, and then issues a credential to the member that is used to form a DAA private key of the member. As further described herein, the prover is a person or entity that is trying to prove membership in the group. If the prover is indeed a member in the group and has a valid DAA private key, the proof should be successful. As further described herein, the verifier is the entity that is trying to establish whether the prover is a member of the group or not. So the prover is trying to prove membership to the verifier.

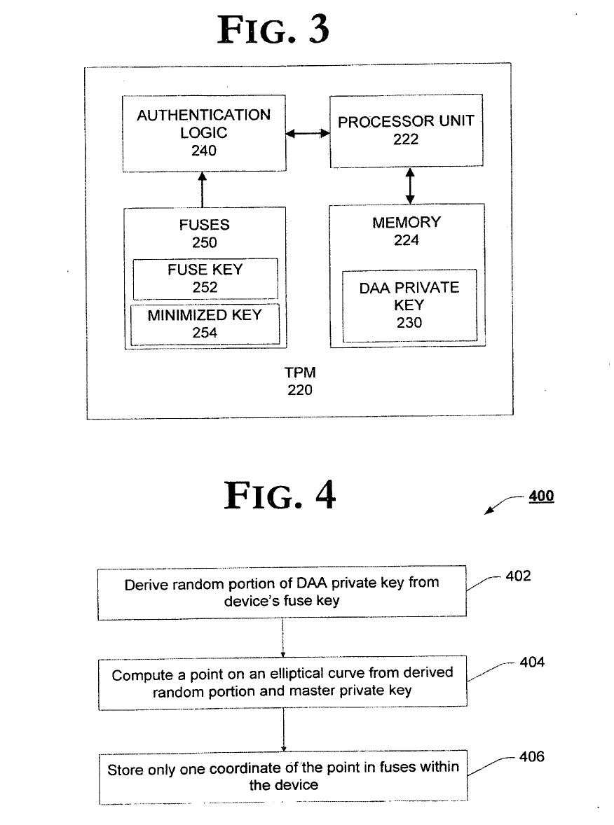

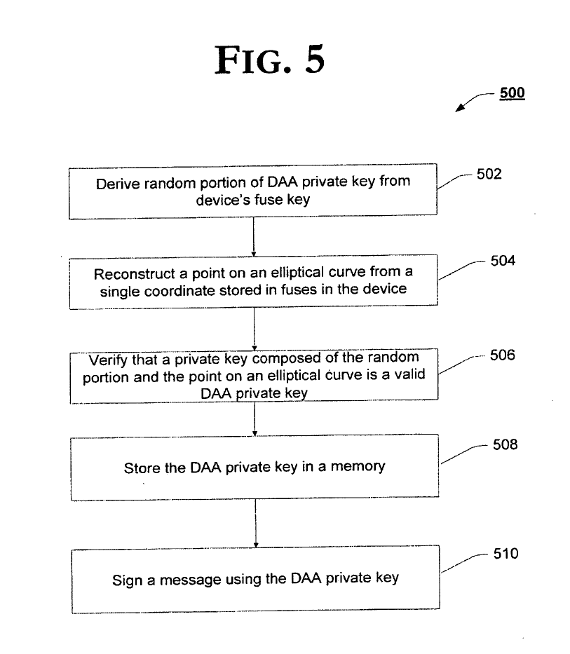

FIG. 4 is a flowchart illustrating a method 400 for minimizing the storage of a DAA private key, in accordance with one embodiment. Let (p, g₁, g₂, g₃, G₁ G₂, G₃, w) be the group pubic key, where G₁ is a sub-group of an elliptic curve group E over a prime field F_{q}, where E:y²=x³+ax+b. Let FK be the platform's fuse key. Issuer 110 first obtains fuse key 252. It derives (402) the random part of DAA private key from the fuse key. In one embodiment, the issuer derives a random value x between [0, p-1] from the fuse key FK. One way to derive x is to compute x=Hash(FK, “ECC-DAA”) mod p.

Then issuer 110 computes (404) the other part of the DAA private key based on its master private key and on the derived random part of the DAA key. The issuer computes A=g₁^{1/(γ+x)}. The value (A, x) is the DAA private key. Let A=(A.x, A.y), a point on the elliptic curve E, where A.x and A.y are integers.

Given that the non-random portion of DAA private key contains points on an elliptic curve, it is an object of the present invention to further reduce the size. The result after the point reduction is the minimized storage of the DAA private key. The value A.x is only part of the DAA private key needs to be stored. In other words, the minimized storage of the DAA private key is A.x.

The issuer stores FK and A.x in the fuses of the platform. In one embodiment, issuer 110 stores (406) fuse key 252 and the minimized storage form of the DAA private key (minimized key 254) by selectively blowing fuses 250 of TPM 220.

FIG. 5 is a flowchart illustrating a method 500 for reconstructing a DAA private key from the minimized storage form, in accordance with one embodiment. The hardware device (authentication logic 240 of TPM 220) first reads its fuses key 252 and the DAA private key in minimized storage form 254 from its fuses 250. The platform reads the fuse key FK and the (minimized) storage of DAA private key A.x from its fuses.

It first derives (502) the random part of the DAA private key. The platform derives x from the fuse key, for example, authentication logic 240 computes x=Hash(FK, “ECC-DAA”) mod p. Note that the platform must use the same derivation function as the issuer.

Authentication logic 240 then uses point recovery to find the other part of DAA private key. Since there are two possible points after point recovery, the device chooses one of them and verifies whether it is a valid DAA private key. In one embodiment, authentication logic 240 reconstructs (504) A from A.x by solving the equation A.y²=A.x²+a·A.x+b (mod q) for A.y. There are two possible A.y. Authentication logic 240 chooses one of them and sets A=(A.x, A.y). Authentication logic 240 verifies (506) whether (A, x) is a valid DAA private key by verifying e(A, w g₂^{x})=e(g₁, g₂).

If (A, x) is a valid DAA private key, authentication logic 240 stores (508) the DAA private key 230 in memory 224. If (A, x) is not a valid private key, the platform sets A=−A (the inverse of A), and repeats the verification step.

Authentication logic 240 may then sign (510) a message using DAA private key 230.

It is to be understood that even though numerous characteristics and advantages of various embodiments of the present invention have been set forth in the foregoing description, together with details of the structure and function of various embodiments of the invention, this disclosure is illustrative only. In some cases, certain subassemblies are only described in detail with one such embodiment. Nevertheless, it is recognized and intended that such subassemblies may be used in other embodiments of the invention. Changes may be made in detail, especially matters of structure and management of parts within the principles of the embodiments of the present invention to the full extent indicated by the broad general meaning of the terms in which the appended claims are expressed.

Having disclosed exemplary embodiments and the best mode, modifications and variations may be made to the disclosed embodiments while remaining within the scope of the embodiments of the invention as defined by the following claims.

What is claimed is:

1. A method comprising:
deriving a random portion of a direct anonymous attestation (DAA) private key from a device's fuse key;
computing a point on an elliptical curve from the derived random portion and a master private key; and
storing only one coordinate of the point in fuses within the device.

2. The method of claim 1, wherein the device comprises a chipset.

3. The method of claim 1, wherein the one coordinate of the point comprises 256 bits.

4. The method of claim 1, wherein deriving a random portion of a direct anonymous attestation (DAA) private key from a device's fuse key comprises computing x=Hash(FK, “ECC-DAA”) mod p.

5. A method comprising:
deriving a random portion of a direct anonymous attestation (DAA) private key from a device's fuse key;
reconstructing a point on an elliptical curve from a single coordinate stored in fuses in the device;
verifying that a private key composed of the random portion and the point on an elliptical curve is a valid DAA private key; and
storing the DAA private key in a memory.

6. The method of claim 5, wherein the device comprises a chipset.

7. The method of claim 5, further comprising signing a message using the DAA private key.

8. The method of claim 5, wherein the single coordinate stored in fuses in the device comprises 256 bits.

9. The method of claim 5, wherein deriving a random portion of a direct anonymous attestation (DAA) private key from a device's fuse key comprises computing x=Hash(FK, “ECC-DAA”)mod p.

10. The method of claim 5, wherein the memory comprises flash memory.

11. The method of claim 5, wherein verifying that a private key composed of the random portion and the point on an elliptical curve is a valid DAA private key comprises verifying e(A, wg₂^{x})=e(g₁, g₂).

12. The method of claim 5, wherein reconstructing a point on an elliptical curve from a single coordinate stored in fuses in the device comprises solving the equation A.y²=A.x²+a A.x+b(mod q) for A.y.

13. An apparatus comprising:
a memory;
a fuse key;
a minimized direct anonymous attestation (DAA) private key stored in fuses, wherein the fuse-stored minimized DAA private key only includes one coordinate of a point on an elliptical curve; and
authentication logic to:
derive a random portion of a direct anonymous attestation (DAA) private key from the fuse key;
reconstruct a point on an elliptical curve from the fuse-stored minimized DAA private key;
verify that a private key composed of the random portion and the point on an elliptical curve is a valid DAA private key; and
store the DAA private key in the memory.

14. The apparatus of claim 13, wherein the apparatus comprises a chipset.

15. The apparatus of claim 13, further comprising the authentication logic to sign a message using the DAA private key.

16. The apparatus of claim 13, wherein the fuse-stored minimized DAA private key comprises 256 bits.

17. The apparatus of claim 13, wherein the authentication logic to derive a random portion of a direct anonymous attestation (DAA) private key from the fuse key comprises the authentication logic to compute x=Hash(FK, “ECC-DAA”) mod p.

18. The apparatus of claim 13, wherein the memory comprises flash memory.

19. The apparatus of claim 13, wherein the authentication logic to verify that a private key composed of the random portion and the point on an elliptical curve is a valid DAA private key comprises the authentication logic to verify e(A, wg₂^{x})=e(g₁, g₂).

20. The apparatus of claim 13, wherein the authentication logic to reconstruct a point on an elliptical curve from the fuse-stored minimized DAA private key comprises the authentication logic to solve the equation A.y²=A.x²+a A.x+b (mod q) for A.y.
